(19) United States
(12) Patent Application Publication
(10) Pub. No.: US 2008/0253467 A1
(43) Pub. Date: Oct. 16, 2008

(54) SYSTEM AND METHOD FOR USING REDUNDANT PICTURES FOR INTER-LAYER PREDICTION IN SCALABLE VIDEO CODING

(75) Inventors: Ye-Kui Wang, Tampere (FI); Miska Hannuksela, Ruutana (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/101,035

(22) Filed: Apr. 10, 2008

Related U.S. Application Data
(60) Provisional application No. 60/911,833, filed on Apr. 13, 2007.

(51) Int. Cl. H04N 7/24

(52) U.S. Cl. 375/240.26; 375/240.12; 375/E07.011

(57) ABSTRACT

A system and method for indicating whether a redundant picture can be used to replace a corresponding primary picture for inter-layer prediction. Various embodiments involve the use of a property of a redundant picture in relation to the corresponding primary picture. Based on such a property, a decoder can derive whether the redundant picture or a portion thereof can be utilized for inter-layer prediction of intra texture, macroblock coding mode, motion, and/or residual properties.

### CROSS-REFERENCE TO RELATED APPLICATIONS

The present application claims priority to U.S. Provisional Patent Application No. 60/911,833, filed Apr. 13, 2007.

### FIELD OF THE INVENTION

The present invention relates generally to scalable video coding. More particularly, the present invention relates to the use of redundant pictures in scalable video coding.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also know as ISO/IEC MPEG-4 AVC). In addition, there are currently efforts underway with regards to the development of new video coding standards. One such standard under development is the scalable video coding (SVC) standard, which will become the scalable extension to H.264/AVC. Another such standard under development is the multi-view video coding (MVC), which will become another extension to H.264/AVC. A draft of the SVC standard is available in JVT-U202, “Joint Scalable Video Model 8: Joint Draft 8 with proposed changes”, 21^{st} JVT meeting, Hangzhou, China, October 2006, available from ftp3.itu.ch/av-arch/jvt-site/2006_{—}10_Hangzhou/JVT-U202.zip.

H.264/AVC includes a feature that is referred to as redundant pictures. A redundant picture is a redundant coded representation of a primary picture, i.e., the picture that is to be decoded if there are no transmission errors. A redundant picture does not have to cover the entire region of the primary picture. Each primary coded picture may have up to 127 redundant pictures. After decoding, the region represented by a redundant picture should be similar in quality as the same region represented by the corresponding primary picture. The coding of redundant pictures can be applied to control transmission errors in the following way: if a region represented in the primary picture is lost or corrupted due to transmission errors, a correctly received redundant picture contains the same region can be used to reconstruct that region. A redundant picture is identified by the syntax element redundant_pic_cnt with a value greater than 0.

In scalable video coding, a video signal can be encoded into a base layer and one or more enhancement layers constructed in a pyramidal fashion. An enhancement layer enhances the temporal resolution (i.e., the frame rate), the spatial resolution, or simply the quality of the video content represented by another layer or part thereof. Each layer, together with all of its dependent layers, is one representation of the video signal at a certain spatial resolution, temporal resolution and quality level. A scalable layer, together with all of its dependent layers, is referred to herein as a “scalable layer representation.” The portion of a scalable bitstream corresponding to a scalable layer representation can be extracted and decoded to produce a representation of the original signal at certain fidelity.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS). In contrast to FGS, the scalability provided by those enhancement layers that cannot be truncated is referred to as coarse-grained (granularity) scalability (CGS). It collectively includes the traditional quality (SNR) scalability and spatial scalability. The SVC draft standard also supports the “medium-grained scalability” (MGS), where quality enhancement pictures are coded similarly to SNR scalable layer pictures but indicated by high-level syntax elements in a manner similar to FGS layer pictures.

SVC uses the same mechanism as H.264/AVC to provide temporal scalability. SVC uses an inter-layer prediction mechanism, where certain information can be predicted from layers other than the currently reconstructed layer or the next lower layer. Information that can be inter-layer predicted includes intra texture, macroblock coding mode, motion and residual data. Inter-layer motion prediction includes the prediction of block coding mode, header information, etc., wherein motion from the lower layer may be used for prediction of the higher layer. In the case of intra coding, a prediction from surrounding macroblocks or from co-located macroblocks of lower layers is possible. These prediction techniques do not employ motion information and hence, are referred to as intra prediction techniques. Furthermore, residual data from lower layers can also be employed for prediction of the current layer.

When compared to older video compression standards, SVC's spatial scalability has been generalized to enable the base layer to be a cropped and zoomed version of the enhancement layer. The quantization and entropy coding modules have also been adjusted to provide FGS capability. The coding mode is referred to as progressive refinement, where successive refinements of the transform coefficients are encoded by repeatedly decreasing the quantization step size and applying a “cyclical” entropy coding akin to sub-bitplane coding.

SVC specifies a concept known as single-loop decoding. Single-loop decoding is enabled by using a constrained intra texture prediction mode, whereby the inter-layer intra texture prediction can be applied to macroblocks (MBs) for which the corresponding block of the base layer is located inside intra-coded macroblocks (intra-MBs). At the same time, those intra-MBs in the base layer use the constrained intra prediction mode, wherein the intra prediction signal only comes from intra-coded neighboring blocks. In single-loop decoding, the decoder needs to perform motion compensation and full picture reconstruction only for the scalable layer desired for playback (referred to herein as the desired layer), thereby greatly reducing decoding complexity. All of the layers other than the desired layer do not need to be fully decoded because all or part of the data of the macroblocks not used for inter-layer prediction (be it inter-layer intra texture prediction, inter-layer motion prediction or inter-layer residual prediction) is not needed for reconstruction of the desired layer. A single decoding loop is needed for the decoding of most pictures. A second decoding loop is applied to reconstruct the base representations, which are needed for prediction reference but not for output or display, and are reconstructed only for the “key pictures.”

The scalability structure in the SVC draft is characterized by three syntax elements: temporal_id, dependency_id and quality_id. The syntax element temporal_id is used to indicate the temporal scalability hierarchy or, indirectly, the frame rate. A scalable layer representation comprising pictures of a smaller maximum temporal_id value has a smaller frame rate than a scalable layer representation comprising pictures of a greater maximum temporal_id. A given temporal layer typically depends on the lower temporal layers (i.e., the temporal layers with smaller temporal_id values) but never depends on any higher temporal layer. The syntax element dependency_id is used to indicate the CGS inter-layer coding dependency hierarchy (which, as mentioned earlier, includes both SNR and spatial scalability). At any temporal level location, a picture of a smaller dependency_id value may be used for inter-layer prediction for coding of a picture with a larger dependency_id value. The syntax element quality_id is used to indicate the quality level hierarchy of a FGS or MGS layer. At any temporal location, and with an identical dependency_id value, a picture with quality_id equal to QL uses the picture with a quality_id equal to QL-1 for inter-layer prediction. A coded slice with a quality_id larger than 0 may be coded as either a truncatable FGS slice or a non-truncatable MGS slice. Coded slides are encapsulated in Network Abstraction Layer (NAL) units, which may also encapsulate various types of coded data such as parameter sets and Supplemental Enhancement Information (SEI) messages. All NAL units pertaining to a certain time form an access unit. For simplicity, all of the data units (i.e. Network Abstraction Layer units or NAL units in the SVC context) in one access unit having identical dependency_id values are referred to as a dependency unit, and all the data units in one dependency unit having identical quality_id values are referred to as a quality unit.

A coded video bitstream may include extra information to enhance the use of the video for a wide variety purposes. For example, SEI and video usability information (VUI), as defined in H264/AVC, provide such a functionality. The H.264/AVC standard and its extensions include the support of SEI signaling through SEI messages. SEI messages are not required by the decoding process to generate correct sample values in output pictures. Rather, SEI messages are helpful for other purposes such as error resilience and display. H.264/AVC contains the syntax and semantics for the specified SEI messages.

### SUMMARY OF THE INVENTION

Various embodiments of the present invention provide a system and method by which it can be indicated whether a redundant picture can be used to replace a corresponding primary picture for inter-layer prediction. In particular, various embodiments of the present invention involve the use of a property of a redundant picture in relation to the corresponding primary picture. Based on such a property, the decoder can derive whether the redundant picture or a portion thereof can be utilized for inter-layer prediction of intra texture, macroblock coding mode, motion, and/or residual properties. Therefore, the decoder is capable of deciding how to continue the decoding such that the decoded video quality is maximized or otherwise improved.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 shows a generic multimedia communications system for use with the present invention;

FIG. 2 is a flow chart showing the implementation of various embodiments of the present invention;

FIG. 3 is a perspective view of a mobile device that can be used in the implementation of the present invention; and

FIG. 4 is a schematic representation of the device circuitry of the mobile device of FIG. 3.

### DETAILED DESCRIPTION OF VARIOUS EMBODIMENTS

In light of the above, an issue exists concerning the use of redundant pictures for replacing a corresponding primary picture for inter-layer prediction. This issue is demonstrated by an example where it is assumed that there is one SVC bitstream containing two layers identified by dependency_id equal to 0 and 1, respectively. In a certain access unit, the base layer dependency unit (with dependency_id equal to 0) contains a redundant picture (with redundant_pic_cnt equal to 1) in addition to the primary picture (with redundant_pic_cnt equal to 0). The enhancement layer dependency unit (with dependency_id equal to 1) utilizes the base layer primary picture for inter layer prediction.

It is possible that the redundant picture in the base layer is encoded the same as the primary picture in the base layer, with the only difference being in the redundant_pic_cnt value. In this case, if the primary picture in the base layer is lost, while the redundant picture is received by the decoder, the redundant picture can be used to replace the primary picture for any type of inter-layer prediction.

In addition, it is also possible that the redundant picture is encoded differently than the primary picture in the base layer. For example, the redundant picture may be encoded using a different quantization parameter, while other parameters (including motion information) are the same as the primary picture. In this case, if the primary picture in the base layer is lost while the redundant picture is received by the decoder, the redundant picture can be used to replace the primary picture for inter-layer motion prediction. However, residual information is different due to use of different quantization parameters. Therefore, in this situation the redundant picture cannot be used to replace the primary picture for inter-layer residual prediction.

According to the current design of the SVC standard, there is no way to indicate whether a redundant picture can be used to replace the corresponding primary picture for inter-layer prediction. When the primary picture, or a portion of the primary picture, is lost during transmission, the decoder has no way of determining whether the redundant picture is of sufficient quality to use for continued decoding.

Various embodiments of the present invention provide a system and method by which it can be indicated whether a redundant picture can be used to replace a corresponding primary picture for inter-layer prediction. In particular, various embodiments of the present invention involve the use of a property of a redundant picture in relation to the corresponding primary picture. Based on such a property, the decoder can derive whether the redundant picture or a portion thereof can be utilized for inter-layer prediction of intra texture, macroblock coding mode, motion, or residual properties. Therefore, the decoder is capable of deciding how to continue the decoding such that the decoded video quality is maximized or otherwise improved.

In one particular embodiment, a first flag is associated with each redundant picture in a scalable video bitstream. This flag indicates whether or not the redundant picture is an exact copy of the corresponding primary picture, with the only difference being in the redundant_pic_cnt value. Based on this property, the decoder can be certain that using the redundant picture would be equivalent to using the primary picture for any type of inter-layer prediction.

In another embodiment of the present invention, a second flag is associated with each redundant picture. This flag indicates whether or not the macroblock coding modes (indicated by mb_type in SVC) for all or a portion of the macroblocks in the redundant picture are identical to the corresponding macroblocks in the primary picture. Based on this property, the decoder knows that using the redundant picture is equivalent to using the primary picture for inter-layer prediction of macroblock coding modes.

In yet another embodiment, a third flag is associated with each redundant picture. This flag indicates whether or not the motion information of all or a portion of the macroblocks in the redundant picture is identical to the corresponding macroblocks in the primary picture. Therefore, the decoder knows in this situation that using the redundant picture is equivalent to using the primary picture for inter-layer prediction of motion information.

In a further embodiment, a fourth flag is associated with each redundant picture. This flag indicates whether or not the residual information of all or a portion of the macroblocks in the redundant picture is identical or close to the corresponding macroblocks in the primary picture. Based on this property, the decoder knows that it can use the redundant picture, as the redundant picture is of sufficient quality when compared to using the primary picture so as to be usable for inter-layer prediction of the residual.

In still another embodiment of the invention, a fifth flag is associated with each redundant picture. This flag indicates whether or not the reconstructed sample values of all the intra coded macroblocks in the redundant picture are identical or close to the corresponding macroblocks in the primary picture. Based on this property, the decoder can know that using the redundant picture will be of a sufficient quality, in comparison to the primary picture, to be useable for inter-layer texture prediction.

In addition to the above, it is also understood that any combination of the above flags could be used in conjunction with each other, with some or all of the flags being associated with each redundant picture in a scalable video bitstream. It is also possible that each of the flags is used to indicate the property for part of the redundant picture, e.g., a coded slice or simply a coded macroblock, in relation to the corresponding part of the primary picture.

In each of the above embodiments, the property associated with each redundant picture can be included in the bitstream, e.g., as part of a SEI message or as part of the slice header. The following is an example SEI message that conveys the property:

| redundant_pic_property( payloadSize ) { | | C | Descriptor |
|---|---|---|---|
| | num_dependency_units_minus1 | 5 | ue(v) |
| | for( i = 0; i <= num_dependency_units_minus1; i++ ) { | | |

| | | |
|---|---|---|
| dependency_id[ i ] | 5 | u(3) |
| num_quality_units_minus1[ i ] | 5 | ue(v) |
| for( j = 0; j <= num_quality_units_minus1[ i ]; j++ ) { | | |

| | | |
|---|---|---|
| quality_id[ i ][ j ] | 5 | u(2) |
| num_redundant_pics_minus1[ i ][ j ] | 5 | ue(v) |
| for( k = 0; k <= num_redundant_pics_minus1[ i ][ j ]; k++ ) { | | |

| | | |
|---|---|---|
| redundant_pic_cnt_minus1[ i ][ j ][ k ] | 5 | ue(v) |
| pic_match_flag[ i ][ j ][ k ] | 5 | u(1) |
| if( !pic_match_flag[ i ][ j ][ k ]) { | | |

| | | |
|---|---|---|
| mb_type_match_flag[ i ][ j ][ k ] | 5 | u(1) |
| motion_match_flag[ i ][ j ][ k ] | 5 | u(1) |
| residual_match_flag[ i ][ j ][ k ] | 5 | u(1) |
| intra_samples_match_flag[ i ][ j ][ k ] | 5 | u(1) |

}

}

}

}

}

The information conveyed in the above SEI message concerns an access unit. When present, this SEI message appears before any coded slice NAL unit or coded slice data partition NAL unit of the corresponding access unit.

In the above SEI message, “num_dependency_units_minus1” plus 1 indicates the number of the dependency units for which the redundant picture properties are specified by the following syntax elements. “dependency_id[i]” indicates the dependency_id value of the dependency unit for which the redundant picture properties are specified by the following syntax elements. “num_quality_units_minus1[i]” plus 1 indicates the number of the quality units in the dependency unit having dependency_id equal to dependency_id[i] for which the redundant picture properties are specified by the following syntax elements. “quality_id[i][j]” indicates the quality_id value of the quality unit having a dependency_id equal to dependency_id[i] for which the redundant picture properties are specified by the following syntax elements.

“num_redundant_pics_minus1[i] [j]” plus 1 indicates the number of redundant pictures in the quality unit having a dependency_id equal to dependency_id[i] and a quality_id equal to quality_id[i] [j] for which the redundant picture properties are specified by the following syntax elements. “redundant_pic_cnt_minus1[i][j][k]” plus 1 indicates the redundant_pic_cnt value of the redundant picture having a dependency_id equal to dependency_id[i] and a quality_id equal to quality_id[i] [j] for which the redundant picture properties are specified by the following syntax elements. The redundant picture having a dependency_id equal to dependency_id[i], a quality_id equal to quality_id[i][j], and a redundant_pic_cnt equal to (redundant_pic_cnt_minus1[i][j][k]+1) is referred to as the target redundant picture.

A “pic_match_flag[i][j][k]” value equal to 1 indicates that the target redundant picture is an exact copy of the primary picture, with the only difference being in redundant_pic_cnt. A “mb_type_match_flag[i][j][k]” value equal to 1 indicates that the macroblock coding modes (indicated by mb_type in SVC) for all of the macroblocks in the target redundant picture are identical to the corresponding macroblocks in the primary picture. A “motion_match_flag[i][j][k]” value equal to 1 indicates that the motion information of all of the macroblocks in the redundant picture is identical to the corresponding macroblocks in the primary picture. A “residual_match_flag[i][j][k]” value equal to 1 indicates that the residual information of all of the macroblocks in the redundant picture is identical or close to the corresponding macroblocks in the primary picture. An “intra_samples_match_flag[i][j][k]” equal to 1 indicates that the reconstructed sample values of all of the intra coded macroblocks in the redundant picture are identical or close to the corresponding macroblocks in the primary picture.

In an alternative SEI message design, the loops over num_dependency_units_minus1 and num_quality_units_minus1 are removed from the syntax of the SEI message, and the SEI message is enclosed within the scalable nesting SEI message, which specifies the values of dependency_id and quality_id that the message concerns. An SEI message per each value of dependency_id and quality_id is required, unless several dependency units or quality units share the same redundant pictures that can be used for inter-layer prediction.

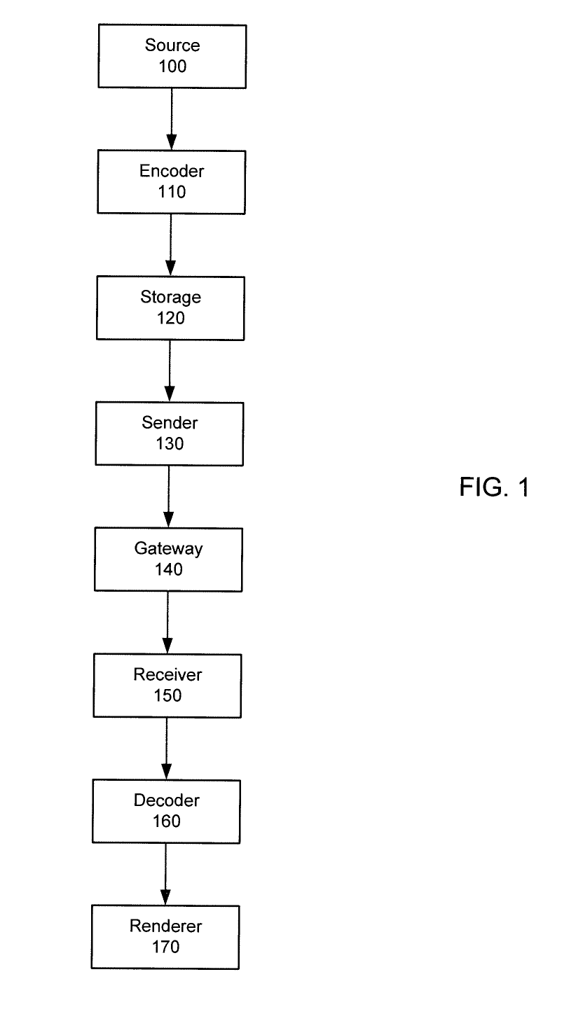

FIG. 1 shows a generic multimedia communications system for use with various embodiments of the present invention. As shown in FIG. 1, a data source 100 provides a source signal in an analog, uncompressed digital, or compressed digital format, or any combination of these formats. An encoder 110 encodes the source signal into a coded media bitstream. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typical real-time broadcast services comprise several streams (typically at least one audio, video and text sub-titling stream). It should also be noted that the system may include many encoders, but in the following only one encoder 110 is considered to simplify the description without a lack of generality.

It should be understood that, although text and examples contained herein may specifically describe an encoding process, one skilled in the art would readily understand that the same concepts and principles also apply to the corresponding decoding process and vice versa.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. Some systems operate “live”, i.e. omit storage and transfer coded media bitstream from the encoder 110 directly to a sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the sender 130 may reside in the same physical device or they may be included in separate devices. The encoder 110 and the sender 130 may operate with live real-time content, in which case the coded media bitstream is typically not stored permanently, but rather buffered for small periods of time in the content encoder 110 and/or in the sender 130 to smooth out variations in processing delay, transfer delay, and coded media bitrate.

The sender 130 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the sender 130 encapsulates the coded media bitstream into packets. For example, when RTP is used, the sender 130 encapsulates the coded media bitstream into RTP packets according to an RTP payload format. Typically, each media type has a dedicated RTP payload format. It should be again noted that a system may contain more than one sender 130, but for the sake of simplicity, the following description only considers one sender 130.

The sender 130 may or may not be connected to a gateway 140 through a communication network. The gateway 140 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 140 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is called an RTP mixer and acts as an endpoint of an RTP connection.

The system includes one or more receivers 150, typically capable of receiving, de-modulating, and de-capsulating the transmitted signal into a coded media bitstream. The codec media bitstream is typically processed further by a decoder 160, whose output is one or more uncompressed media streams. Finally, a renderer 170 may reproduce the uncompressed media streams with a loudspeaker or a display, for example. The receiver 150, the decoder 160, and the renderer 170 may reside in the same physical device or they may be included in separate devices.

It should be noted that the bitstream to be decoded can be received from a remote device located within virtually any type of network. Additionally, the bitstream can be received from local hardware or software.

Scalability in terms of bitrate, decoding complexity, and picture size is a desirable property for heterogeneous and error prone environments. This property is desirable in order to counter limitations such as constraints on bit rate, display resolution, network throughput, and computational power in a receiving device.

Communication devices of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

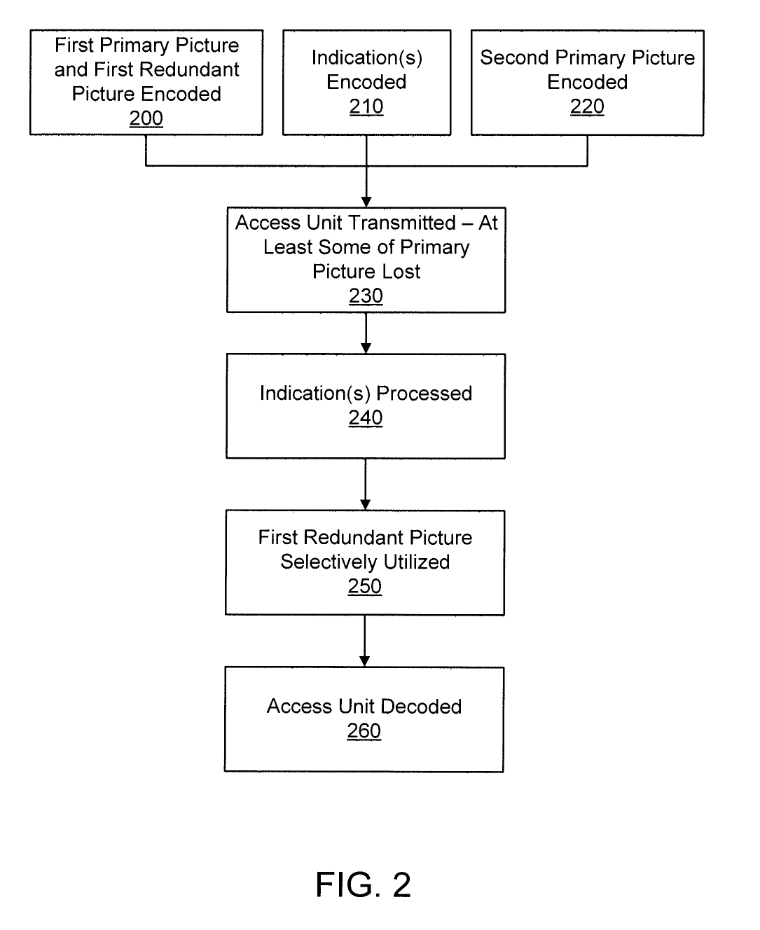

FIG. 2 is a flow chart showing the implementation of various embodiments of the present invention. At 200 in FIG. 2, a first primary picture and a first redundant picture are encoded into an access unit. At 210, one or more indications of at least one property of the first redundant picture are also encoded into the access unit. As discussed previously, the indications encoded into the access unit can indicate, for example, whether the first redundant picture is effectively a copy of the first primary picture. The properties can also represent the types of inter-layer prediction for which the first redundant picture can be used in place of the first primary picture. At 220 and in certain embodiments, a second primary picture, which is dependent upon the first primary picture, is also encoded into the access unit. (It should be noted that 200, 210 and 220 can occur one after the other or substantially simultaneously.) At 230, the access unit is transmitted in the bitstream from an encoding unit to a decoding unit. During this period, at least a portion of the first primary picture is lost. At 240, the decoding unit processes the indications that were previously encoded into the access unit. Based upon these indications, the decoding unit can selectively utilize the first redundant picture or a portion thereof for further decoding at 250. The decoding unit may also utilize the indications for a non-scalable video bitstream. For example, if the motion information of a part of a redundant picture is known identical to the corresponding part of the corresponding primary picture, while the residual signal is known not to be identical or sufficiently close to identical, the decoding unit can utilize the motion information of the part of the redundant picture for error concealment while discarding the residual signal. At 260, the access unit is decoded from the bitstream.

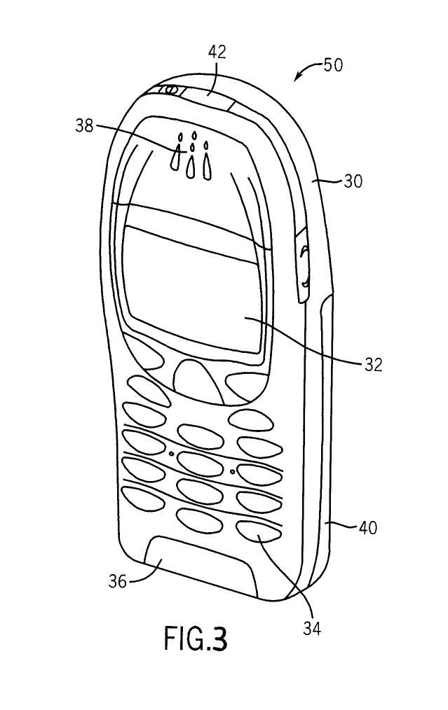

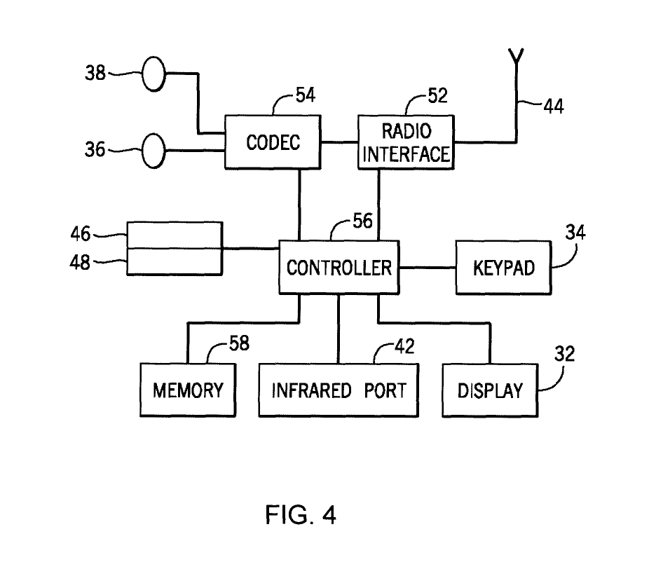

FIGS. 3 and 4 show one representative electronic device 50 within which the present invention may be implemented. It should be understood, however, that the present invention is not intended to be limited to one particular type of device. The electronic device 50 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method of encoding a video bitstream, comprising:
encoding a picture into an access unit, the access unit comprising:
a first primary picture;
a first redundant picture; and
at least one indication of at least one property of the first redundant picture in relation to the first primary picture.

2. The method of claim 1, wherein the at least one indication indicates at least one of:
whether the first redundant picture is effectively a copy of the first primary picture;
whether block coding modes for all blocks in the first redundant picture are identical to corresponding blocks in the first primary picture;
whether motion information of all blocks in the first redundant picture is identical to corresponding blocks in the first primary picture;
whether residual information of all blocks in the first redundant picture is identical or close to corresponding blocks in the first primary picture; and
whether reconstructed sample values of all of the intra coded blocks in the first redundant picture are identical or close to corresponding blocks in the first primary picture.

3. The method of claim 1, wherein the at least one indication is included in a supplemental enhancement information message.

4. The method of claim 1, further comprising encoding a second primary picture into the access unit, the second primary picture being dependent upon the first primary picture.

5. The method of claim 4, wherein the at least one property comprises at least one type of inter-layer prediction for which the first redundant picture can be used in place of the first primary picture.

6. The method of claim 5, wherein the at least one type of inter-layer prediction includes macroblock coding mode prediction.

7. The method of claim 5, wherein the at least one type of inter-layer prediction includes motion prediction.

8. The method of claim 5, wherein the at least one type of inter-layer prediction comprises residual prediction.

9. The method of claim 5, wherein the at least one type of inter-layer prediction includes sample value prediction.

10. A computer program product, embodied in a computer-readable medium, comprising computer code configured to perform the processes of claim 1.

11. An apparatus, comprising:
a processor; and
a memory unit communicatively connected to the processor and including computer code for encoding a picture into an access unit, the access unit comprising:
a first primary picture;
a first redundant picture; and
at least one indication of at least one property of the first redundant picture in relation to the first primary picture.

12. The apparatus of claim 11, wherein the at least one indication indicates at least one of:
whether the first redundant picture is effectively a copy of the first primary picture;
whether block coding modes for all blocks in the first redundant picture are identical to corresponding blocks in the first primary picture;
whether motion information of all blocks in the first redundant picture is identical to corresponding blocks in the first primary picture;
whether residual information of all blocks in the first redundant picture is identical or close to corresponding blocks in the first primary picture; and
whether reconstructed sample values of all of the intra coded blocks in the first redundant picture are identical or close to corresponding blocks in the first primary picture.

13. The apparatus of claim 11, wherein the at least one indication is included in a supplemental enhancement information message.

14. The apparatus of claim 11, wherein the memory unit further comprises computer code for encoding a second primary picture into the access unit, the second primary picture being dependent upon the first primary picture.

15. The apparatus of claim 11, wherein the at least one property comprises at least one type of inter-layer prediction for which the first redundant picture can be used in place of the first primary picture.

16. The apparatus of claim 15, wherein the at least one type of inter-layer prediction includes at least one of macroblock coding mode prediction, motion prediction, residual prediction, and sample value prediction.

17. An apparatus, comprising:
means for encoding a picture into an access unit, the access unit comprising:
a first primary picture;
a first redundant picture; and
at least one indication of at least one property of the first redundant picture in relation to the first primary picture.

18. The apparatus of claim 17, wherein the at least one indication indicates at least one of:
whether the first redundant picture is effectively a copy of the first primary picture;
whether block coding modes for all blocks in the first redundant picture are identical to corresponding blocks in the first primary picture;
whether motion information of all blocks in the first redundant picture is identical to corresponding blocks in the first primary picture;
whether residual information of all blocks in the first redundant picture is identical or close to corresponding blocks in the first primary picture; and
whether reconstructed sample values of all of the intra coded blocks in the first redundant picture are identical or close to corresponding blocks in the first primary picture.

19. The apparatus of claim 17, wherein the at least one property comprises at least one type of inter-layer prediction for which the first redundant picture can be used in place of the first primary picture.

20. A method for decoding a video bitstream, comprising:
processing at least one indication contained within a received access unit including a first redundant picture, the at least one indication being of at least one property of the first redundant picture in relation to a first primary picture; and
selectively utilizing the first redundant picture for further decoding based upon the at least one indication.

21. The method of claim 20, wherein the at least one indication indicates at least one of:
whether the first redundant picture is effectively a copy of the first primary picture;
whether block coding modes for all blocks in the first redundant picture are identical to corresponding blocks in the first primary picture;
whether motion information of all blocks in the first redundant picture is identical to corresponding blocks in the first primary picture;
whether residual information of all blocks in the first redundant picture is identical or close to corresponding blocks in the first primary picture; and
whether reconstructed sample values of all of the intra coded blocks in the first redundant picture are identical or close to corresponding blocks in the first primary picture.

22. The method of claim 20, wherein the at least one indication is included in a supplemental enhancement information message.

23. The method of claim 20, wherein the access unit further includes a second primary picture, the second primary picture being dependent upon the first primary picture.

24. The method of claim 20, wherein the at least one property comprises at least one type of inter-layer prediction for which the first redundant picture can be used in place of the first primary picture.

25. The method of claim 24, wherein the at least one type of inter-layer prediction includes macroblock coding mode prediction.

26. The method of claim 24, wherein the at least one type of inter-layer prediction includes motion prediction.

27. The method of claim 24, wherein the at least one type of inter-layer prediction comprises residual prediction.

28. The method of claim 24, wherein the at least one type of inter-layer prediction includes sample value prediction.

29. A computer program product, embodied in a computer-readable medium, comprising computer code configured to perform the processes of claim 20.

30. An apparatus, comprising:
a processor; and
a memory unit communicatively connected to the processor and including:
computer code for processing at least one indication contained within a received access unit including a first redundant picture, the at least one indication being of at least one property of the first redundant picture in relation to a first primary picture; and
computer code for selectively utilizing the first redundant picture for further decoding based upon the at least one indication.

31. The apparatus of claim 30, wherein the at least one indication indicates whether the first redundant picture is effectively a copy of the first primary picture.

32. The apparatus of claim 30, wherein the at least one indication is included in a supplemental enhancement information message.

33. The apparatus of claim 30, wherein the access unit further includes a second primary picture, the second primary picture being dependent upon the first primary picture.

34. The apparatus of claim 30, wherein the at least one property comprises at least one type of inter-layer prediction for which the first redundant picture can be used in place of the first primary picture.

35. The apparatus of claim 34, wherein the at least one type of inter-layer prediction includes at least one of macroblock coding mode prediction, motion prediction, residual prediction, and sample value prediction.

36. An apparatus, comprising:
means for processing at least one indication contained within a received access unit including a first redundant picture, the at least one indication being of at least one property of the first redundant picture in relation to a first primary picture; and
means for selectively utilizing the first redundant picture for further decoding based upon the at least one indication.

37. The apparatus of claim 36, wherein the at least one indication indicates at least one of:
whether the first redundant picture is effectively a copy of the first primary picture;
whether block coding modes for all blocks in the first redundant picture are identical to corresponding blocks in the first primary picture;
whether motion information of all blocks in the first redundant picture is identical to corresponding blocks in the first primary picture;
whether residual information of all blocks in the first redundant picture is identical or close to corresponding blocks in the first primary picture; and
whether reconstructed sample values of all of the intra coded blocks in the first redundant picture are identical or close to corresponding blocks in the first primary picture.

38. The apparatus of claim 36, wherein the at least one property comprises at least one type of inter-layer prediction for which the first redundant picture can be used in place of the first primary picture.

39. An apparatus for encoding a video bitstream, comprising:
an encoder configured to encode a picture into an access unit, the access unit comprising:
a first primary picture;
a first redundant picture; and
at least one indication of at least one property of the first redundant picture in relation to the first primary picture.

40. The apparatus of claim 39, wherein the at least one indication indicates at least one of:
whether the first redundant picture is effectively a copy of the first primary picture;
whether block coding modes for all blocks in the first redundant picture are identical to corresponding blocks in the first primary picture;
whether motion information of all blocks in the first redundant picture is identical to motion information of corresponding blocks in the first primary picture;
whether residual information of all blocks in the first redundant picture is identical or close to residual information of corresponding blocks in the first primary picture; and
whether reconstructed sample values of all of the intra coded blocks in the first redundant picture are identical or close to reconstructed sample values of corresponding blocks in the first primary picture.

41. The apparatus of claim 39, wherein the at least one indication is included in a supplemental enhancement information message.

42. An apparatus for decoding a video bitstream, comprising:
a decoder configured to:
process at least one indication contained within a received access unit including a first redundant picture, the at least one indication being of at least one property of the first redundant picture in relation to a first primary picture; and
selectively utilize the first redundant picture for further decoding based upon the at least one indication.

43. The apparatus of claim 42, wherein the at least one indication indicates at least one of:
whether the first redundant picture is effectively a copy of the first primary picture;
whether block coding modes for all blocks in the first redundant picture are identical to corresponding blocks in the first primary picture;
whether motion information of all blocks in the first redundant picture is identical to motion information of corresponding blocks in the first primary picture;
whether residual information of all blocks in the first redundant picture is identical or close to residual information of corresponding blocks in the first primary picture; and
whether reconstructed sample values of all of the intra coded blocks in the first redundant picture are identical or close to reconstructed sample values of corresponding blocks in the first primary picture.

44. The apparatus of claim 42, wherein the at least one indication is included in a supplemental enhancement information message.
